(19) United States
(12) Patent Application Publication
(10) Pub. No.: US 2020/0043357 A1
(43) Pub. Date: Feb. 6, 2020

(54) SYSTEM AND METHOD OF USING INTERACTIVE GAMES AND TYPING FOR EDUCATION WITH AN INTEGRATED APPLIED NEUROSCIENCE AND APPLIED BEHAVIOR ANALYSIS APPROACH

(71) Applicant: Jamie Lynn Juarez, Glendora, CA (US)

(72) Inventor: Jamie Lynn Juarez, Glendora, CA (US)

(21) Appl. No.: 16/147,562

(22) Filed: Sep. 28, 2018

Related U.S. Application Data
(60) Provisional application No. 62/564,570, filed on Sep. 28, 2017.

(51) Int. Cl. G09B 17/00; G09B 13/04

(52) U.S. Cl. CPC G09B 17/003; G09B 13/04

(57) ABSTRACT

A system and method for establishing educational and behavioral advancements in the areas of reading, spelling, phonetics, and typing with novel applications of educational psychology, applied neuroscience, and applied behavioral analysis; this includes novel enhancements in facilitated working memory, visual motor integration, and interhemispheric communication areas of the brain; crucial skill development establishment by means of employing multifaceted visual graphics quickly prompted with whole word matching graphics by means of a 2D and 3D computing keyboard and individualized keyboard letters, fading the whole word prompt, random rotation of those letter choices and letter scrambles comprising a whole word, gradient scaffolding, and fading the randomly rotated letters graphically in computing keyboard format to a blank field without any whole word or letter keyboard graphic prompts; this invention can be implemented in multiple formats, such as printed, games, the display of a computing device, and others.

### CROSS-REFERENCE TO RELATED APPLICATIONS

This patent application claims the benefits of U.S. Provisional Patent Application Ser. No. 62/564,570, filed, Sep. 28, 2017, titled “An integrated neuroscience and applied behavioral analysis educational method used for treating learner in a product line of games, digital technology, and toys specifically targeting behavior, memory, social, speech and language, and sensory motor in the retail and e-commerce spaced organized specifically by targeted therapy need” the entire contents of which is hereby expressly incorporated by reference.

### FIELD OF THE INVENTION

The present invention relates generally to applied neuroscience and applied behavior analysis, and more specifically to system and method for education.

### BACKGROUND

Many businesses, organizations, governments, and other related providers are responsible for the developmental advancements of individual learners with the use of educational and behavioral methodologies. The two primary methodological interventions, education and behavior, are increasingly confronting challenges considering the newly developed applied neuroscience models. Applied neuroscience and dichotomized behavior understandings concluding in new educational methods are increasingly yielding new data on past errors in analysis. Excitingly, an invention generally to applied neuroscience and applied behavior analysis, and more specifically to system and method for education offers optimized learning potentials.

This equally provides rapid advancements in specific skill sets of individuals acquiring reading, spelling, and typing mastery. In addition to improved skills sets, including behavior, memory, social, speech and language, and sensory motor, the culmination in the ability to type, read, and spell when otherwise thought incapable occurs by use of our methodological invention. For current providers in the field of education and behavior, applying and implementing neuroscience derived methodologies can be challenging, misunderstood, tedious, and expensive.

It is desirable for all fields cross correlated (neuroscience, education, behavior analysis, psychotherapy, speech and language, physical therapy, psychophysiology, etc.), as well as fiscally responsible stakeholders (tax payers, insurance companies, school districts, medical associations, etc.) to ensure accurate analysis and optimal methodological interventions advancing one's individualized developmental skills. It is also desirable for concurrent providers to incorporate the latest discoveries yielded by applied neuroscience when they are providing their own methodological frameworks in effort to meet development goals.

The two main schools of applied behavior analysis thought, pivotal response training (PRT) and discrete trial training (DTT) can impede in rapid development of educational acquisition when lacking applied neuroscience system and method. DTT is more highly structured external reinforcement focused and is useful for teaching specific behavioral, educational and language skills. PRT is more highly naturalized internal reinforcement focused and is useful for teaching broader behavioral, educational and language skills. Employing a meta-analyzed model of these therapies to meet individualized needs is crucial.

There are two types of ways to motivate: internal and external. Internal motivations are generally more powerful than external, evolving from naturally occurring primary reinforcements, such as food and water. External motivation is powerful as well. However, they evolve from contrived secondary reinforcements, such as social praise, objects, activities, etc. There is a motivational interaction always present between behavior and communication acquisition, dependent on environment and the consequences within the environment. Natural environment increases the learner's internal motivation, encouraging communicative responses when prompted rapidly by the presenters, and when encouraged to point to a keyboard commonly in their natural environment.

Educational system and method derived applied neuroscience and applied behavioral analysis increases motivation relying on internal reinforcements and external reinforcements simultaneously must occur to optimize learning potential. Incorporating visual, auditory, and motor planning with working memory strategies within education constructs must occur.

We must redefine the accurate, reflective individualized skills of learners to achieve optimal, humanitarian functioning. The mindset that those with observable lacking skills and attentive behavior learn slower or have ceilings of learning is simply erroneous. Individual learners simply process and express differently than the normative samples we have traditionally compared them to for decades. Neuroscience is proving this.

Learners simply process and express differently among each other, and it is our job to innovate new ways of achieving individualized success. We must have innovative methods for helping the epidemic proportions of learners with skills deficits or delays for the good of humanity, as well as for societal benefit. We want our future generations to prosper, be treated with integrity, and have equal opportunities optimizing learning potentials. This is why using our system and method, Your Learner Can Type, is desperately needed.

### SUMMARY

This invention, which for the purposes of this application is referred to as “Your Child Can Type” or “YCCT”, in some embodiments is an innovative system and method designed generally from meta-analyzed, evidence-based and/or emerging, evidence-based and/or promising practice methodologies among typically neuroscience, education, behavior analysis, and/or speech and/or language fields. The disclosed invention is generally an education system and method improving preferably reading, spelling, phonetic awareness, and typing skills generally simultaneously while generally improving communication, behavior, working memory and/or visual motor integration among these specific skill sets. In another embodiment, the described inventions can be used for language training, both in an embodiment of learning a foreign language as well as in an embodiment of improving skills with a learner's native language.

The basis principle is that if the learner focuses his/her attention, generally as described in the YCCT system and method, and independent of the various embodiments under which YCCT may be applied (for example, digitally on a computing device, in printed formats, or other formats) then the learner should benefit by repaired or enhanced brain function, with typically enhanced ability to read, spell and type.

According to some embodiments of the disclosed inventions, this system and/or method combines the teaching of visual, motor and phonetic typing skills while generally targeting simultaneously working memory and/or interhemispheric visual motor skills preferably yielding integration of visual motor attention. Neuroscience and applied behavior analysis advancements generally show activating the areas of the brain scientifically generally accepted within that field to be proven to increase attention, working memory, knowledge retrieval, information processing, and/or engagement are crucial for advanced learning.

For the purpose of the system and method of the disclosed invention, this generally indicates knowledge and motivation are noticeably improved by generally stimulating memory retrieval, sensory activation from both sides of the brain's hemispheres, and preferably scaffolding—enabling a learner to solve a problem, carry out a task, or achieve a goal through gradual shedding of outside assistance, and visual motor skills with positive and negative reinforcement. The interaction of these preferably carefully designed phases typically reinforces visual, auditory, and sensory spatial dimensions preferably improving informational processing, working memory, motor processing, and/or fluid intelligence, which are generally considered in the field to be crucial brain functioning processes widely considered to be scientifically proven to be correlated to high performance learning.

Accordingly, the system and method generally teaches preferably highly emphasized visual motor integration, behavior optometry 2D, 3D, auditory, and/or left and right hemispheric tracking skills with optional audio for phonetics.

This initial drag and drop approach preferably establishes visual motor and phonetic integration necessary to type typically equally paired with knowledge based content and ease of skill. The learner preferably will drag and drop colors, numbers, activities, items, and emotions while receiving visual and auditory reinforcement for whole brain functioning. In a desired sequential order of generally scientific evidence based learning processes, the learner preferably then engages in the more difficult tasks calling upon their prior visual, auditory, and sensory knowledge.

In one embodiment, the learner preferably then recalls a previously matched word by typing the correct corresponding letters from a simpler field choice of two letters. Preferably the visual and auditory field becomes larger and harder while typically stimulating informational processing, working memory, visual motor, and fluid attention. In a typical embodiment, instructions and lesson plans are typically included. In other embodiments, the learner may type, read, and spell in different languages typically showing an exemplary provisioning process.

Gradually reinforcing the gradient to skill typing and memorizing letters to compile the accurate spelling of a word while applying gradients relative to words (e.g., using the letters that form those words) combined together with applying the gradient of learning a typical English keyboard is typically embodied. As the learner learns words and their spelling, the learner is simultaneously learning the association of those letters as they appear on a keyboard. In other embodiments, the words with their letters in another language in combination with the letters (as they may very) in another language for the keyboard of such other language.

In some embodiments, this neuroscience and applied behavior analysis advancement system and method applicable to education may be shown to activate the areas of the brain generally considered to be scientifically proven to increase attention, working memory, knowledge retrieval, information processing, and/or engagement that are typically considered to be crucial for advanced learning. In some embodiments, it may be a system and method in computer computing programs, digital application software and physical products to preferably improve education and behavior. Such an embodiment will preferably allow reading, spelling, and typing to occur as visual motor pointing skills, working memory, and/or interhemispheric connectivity processes. An embodiment of an initial drag-and-drop matching approach preferably establishes visual motor and phonetic integration with whole word pairing to visual picture identification, typically correlated to individual letter random rotation choices necessary to read, spell and/or type, preferably equally paired with knowledge-based content and preferably with ease of skill improving focus and/or working memory fully embodied.

In some embodiments the visual motor processing and integration deficits, treated appropriately, preferably make a desirable difference in understanding by the learner from a generally combined neuroscience and applied behavior analysis perspective. The occipital lobes are generally considered to allow for decoding of symbols, pictures, distance, and/or integration of the physical body's awareness. Brain dysfunctions such as these are typically called visual processing disorders.

For example, in the use of one embodiment of this innovation the visual motor integration consists of coordinating visual perceptual skills organized with gross-motor and fine-motor movements with preferable use of the colors blue and yellow to optimize behavior optometry. Integrating visual input with motor output preferably goes hand and hand. Generally this is how humans plan, execute, and monitor gross-motor and fine-motor tasks. The integration of the two is also typically considered to be essential in academic performance, social skills, communication, typing, emotional regulation, and/or self-esteem. This is also how in some embodiments, the diversity of the method calls for lamination to allow the possibility of pointing, tracing, or circling letter searching with a reusable white board marker and/or drawing tool.

The embodiments preferably integrate the rectifying of what are widely considered the eight types of visual processing issues in a multifaceted approach:
1) visual discrimination issues: learners have difficulty distinguishing between two similar letters, shapes, or objects. In typical examples, mixing up letters, confusing d and b and confusing p and q are common.
2) visual figure-ground discrimination issues: learners with this type typically might not be able to pull out a shape or character from the background. Furthermore, they might have trouble locating specific information on a page, with the task often becoming difficult and overwhelming.
3) visual sequencing issues: learners with these issues typically have difficulty telling the order of symbols, words, or images. Skipping sequencing when reading, and reversing or misreading letters, numbers, and words can be commonplace. They might struggle with writing answers on a separate sheet of paper.
4) visual motor processing issues: learners typically have trouble using feedback from the eyes to coordinate the movement of other parts of the body. For example, writing within the lines, not bumping into things, copying from a book, and typing are skills that are lacking.
5) long-term or short-term visual memory issues: learners might have difficulty recalling what they have seen from long-term or short-term math, reading, and spelling prompts. Typing may be a complicated task while trying to read and spell at the same time.
6) visual spatial issues: locating where objects are in space is typically problematic. Judging distance to an object by be complicated, as well as comprehending time, maps, and characters described on paper or in a spoken narrative.
7) visual closure issues: identification of an object, or facial features when only certain parts are visible, is typically impacted. Spelling or word identification may also be impacted due to letters or words vanishing in a narrative structure.
8) letter and symbol reversal issues: switching letters or numbers when writing is typically common. Letter formation may be affected when reading, writing, and performing tasks.

Typical embodiments integrate development to the right-brain and left-brain connections according generally accepted applied neuroscience theories. Differences commonly seen in Quantitative Electroencephalograph, Functional Mill's, and Single Photo Emission Computing Topography scans to the temporal and frontal lobe areas of the brain typically define what is generally considered to be the observable spectrum of various subsets of learner skill set. Theories exist about brain dominance and how it plays a role in thinking and behaving. The general theory of left-brain or right-brain dominance, with each side of the brain controlling different types of thinking, suggests each side plays an integral role. Additionally, learners are typically said to prefer one type of thinking to the other. For example, a person who is “left-brained” is often said to be more logical, analytical, and objective, while a person who is “right-brained” is said to be more intuitive, thoughtful, and subjective. Theories also exist that suggest delayed learners tend to use more of their right brain, with anomalies heavily affecting the left.

If one were to split the brain right down the middle into two symmetrical, or equal, parts, one would have a right and a left hemisphere. Although equal in size, these two sides are not the same and do not carry out the same functions. The left side of the brain is generally considered to be responsible for controlling the right side of the body. It also is generally considered to perform tasks that have to do with logic, such as in science and mathematics. On the other hand, the right hemisphere is generally considered to coordinate the left side of the body and perform tasks that have to do with creativity and the arts. Both hemispheres are connected by the corpus callosum and serve the body in different ways.

According to general left-brain, right-brain dominance theory, the right side of the brain is best at expressive and creative tasks. Some of the abilities that are popularly associated with the right side of the brain include facial recognition, emotional expressions, musical abilities, empathy, color, images, intuition, creativity, etc. The left side of the brain is considered to be generally skillful at logic, expressive language, mathematical, analytical thinking, reasoning, etc.

The corpus callosum, which separates the hemispheres, is also said to be heavily subjectable during developmental periods to interhemispheric conditioning. A brain-based impairment, agenesis of the corpus callosum (ACC), is said to have extremely high co-morbid rates generally explaining behavioral differences among splintered learners. The particular embodied applied neuroscience strategies generally referenced, used and/or expanded upon in this invention system and method apply.

In embodiments of the described system and method of YCCT, for example with a learner dragging and dropping colors, numbers, activities, items, and/or emotions while typically receiving visual and/or auditory reinforcement for whole brain functioning between left and right hemispheres. In an embodied sequential systemic order of typically scientific evidence-based learning processes, the learner in this method then engages in the more difficult memory tasks calling on his or her prior visual, auditory, and sensory knowledge using the physical materials and/or computing-device generated images as described. Preferably the learner then recalls the previously matched word by typing the correct corresponding letters from a simpler field choice of two letters. In subsequent steps of the described physical YCCT processes, the visual and auditory fields generally becomes larger and harder, preferably stimulating informational processing, working memory, visual motor, and/or fluid attention.

General research in this field indicates knowledge and motivation is typically greatly improve by stimulating memory retrieval, sensory activation from both sides of the brain's hemispheres, and/or scaffolding visual motor skills with positive reinforcement. The interaction of these carefully designed phases (with one embodiment shown in the accompanying Figures) in the YCCT system and method reinforces visual, auditory, and sensory spatial dimensions improving informational processing, working memory, motor processing, and fluid intelligence, all typically considered to be crucial brain functioning processes generally considered to be scientifically proven to be correlated to high performance learning.

In some embodiments healthcare law, psychopharmacology, biomedicine, augmentative assistive technology, behavior modification, applied behavioral analysis, discrete trial training, verbal behavior, pivotal response training, video modeling, incidental teaching, rapid prompting method, cognitive behavioral, existential humanism, neuroscience, neurofeedback, biofeedback, evolutionary psychology, relationship development intervention, cogmed working memory, quantitative electroencephalographs, skills, working memory skills, learning, visual perception, and cognitive processing skills are meta analyzed and contributed to the background and science of forming the foundation on top of which the YCCT system and method has been designed.

The preferred embodiment of YCCT is to foster independent learning, attention, working memory, communication, and/or social skills with typing and/or interaction with letters and/or the physical methods described in this application, with a preferably fostering desirable growth in the areas of combined working memory of learner's verbal behaviors: mand, tact, intraverbal, and echoic of which the prior methodologies, and in particular, Psychologist B. F. Skinner failed to address. YYCT in some embodiments preferably facilitate generalized independent learning, communication, language, attention, motor skills, working memory, visual perception, and cognitive processing skills to nonverbal, echoic, and minimally verbal learners without long-term dependence on prompts and supports.

B. F. Skinner defined verbal behavior prior to the invention of computing and gaming technology as, “behavior reinforced through the mediation of other persons. Skinner's applied theory applied to learners did so, however, without an understanding of QWERTY boards and developing computer computing technologies. We now know preferably verbal behavior is typically reinforced and develops within the environment of other verbal individuals with the new development of computing tools and/or games and/or toys comprised of newly developed materials. For example, “Verbal” may now include blowing a horn to get someone's attention, pulling a parent's hand to the refrigerator, speaking vocally, signing, using PECs, typing, or using gestures and facial expressions by use of a computing device emulating such. The global and micro lack of technological and neuroscience advancements by Skinner's prior work is embodied with YCCT. Preferably producing generalized verbal behavior with typing and/or games and or/toys so the learner is preferably motivated to learn independently, demonstrates intellectual readiness, and/or participates in group instruction. This equally leads to preferably improved behavioral, learning, and/or social emotional skills.

Examination of a learner's verbal operant abilities, as defined by Skinner to accurately develop mand, tact, intraverbal, and echoic mastery, is desirably possible more quickly and independently with the use of a QWERTY keyboard paired with such 2D and 3D stimuli. Identifying a learner's understanding of an alphabet's letters (or other symbols, as in the case of some languages) by use of random rotation distractors of letters via pointing and/or dragging and dropping to a preferably laminated keyboard and/or digital keyboard associated with a computing device may be effective when identifying functional communication repertoires and teaching procedures to have the learner produce independent verbal operants.

Delays in a learner's frontal and sensorimotor areas of the brain are typically considered to be one of the single most impacted development areas impeding learning, behavioral, and social emotional advancement. A delay in a learner's lips and voice production may be evident, but generally to a lesser extend when visual symbolic keyboard prompts are available. The delay in such learner's fine-motor, gross-motor, visual motor attention, and/or integration skills can be substantial until employment of YCCT, in which case such delays are preferably shortened and possibly advanced at rapid speeds. Learners using a computing device's and/or physical keyboard and/or games as a means of establishing successful mastery of verbal operants during the application of the YCCT system and methods is described.

### BRIEF DESCRIPTION OF THE DRAWINGS

These and other features, aspects, and advantages of the present invention will become better understood with regard to the following description, appended claims, and accompanying drawings for both digital and physical formatting.

FIG. 1 shows a learner engaging in the use of an embodiment of YCCT system and method which may be available in multiple languages digitally with a physical keyboard prompt on a computing device, as well as with the generalized preferably laminated keyboard and/or form of an augmented assistive communication, preferably blue and/or yellow for behavioral optometry purposes background, according to some embodiments of the disclosed invention.

FIG. 2 depicts the YCCT technology (as may be displayed on a computing device) a preferably exemplifying the 3D graphic object, reinforcement purposed puzzle, the whole word in keyboard format, and optional phonetic prompts according to some embodiments of the disclosed invention.

FIG. 3 illustrates the preferable matching of the whole word in keyboard format prompting the learner to match making an entire word by dragging and dropping, with the use of the computing device keyboard and/or physical game the learner could place a finger on the entire word and drag its identically paired matched word) with continuance visual prompts of the 3D graphic object according to some embodiments of the disclosed invention.

FIG. 4 shows the whole word in keyboard format prompt compared to a letter search among the keyboard letters scrambled with the ability to point to or drag and drop, for example, with the use of the computing device keyboard, the learner could place a finger on the letter “b” of the keyboard and drag it to the first position of the four-position word under the photo of the blue crayon, matching the accurate letters among the whole word prompt, according to some embodiments of the disclosed invention.

FIG. 5 (A-D) shows the whole word in keyboard format prompt compared to the prior letter search among the keyboard with simplified distractor letters in sequential order of the correct spelling with the ability to point or drag and drop to the correct matching letters among the whole word prompt, according to some embodiments of the disclosed invention.

FIG. 6 (A-D) depicts the whole word in keyboard format prompt now faded to transition to independent working memory skills by use of the keyboard format scaffolding the gradient with only one row among the entire keyboard format serving as a distractor to the correct letter among the whole word paired with phonetic prompts, according to some embodiments of the disclosed invention.

FIG. 7 in some embodiments is the preferred final keyboard gradient with an entire keyboard available to a now mastered lower level gradient of tiered keyboard rows. This keyboard available for pointing and/or dragging and dropping the letters among a final whole word and/or visual graphic prompt is embodied.

FIG. 8 (A-E) shows the learner engaging in YCCT system and method available in some embodiments for multiple language purposes as a physical game and/or other interactive formats, according to some embodiments of the disclosed invention. Typically the learner follows sequential process of matching the whole word to the whole word, however, it may be played out of order with letter searches among words and/or letter choices among distractor letters with possibly a whole word prompt transpiring at different times.

FIG. 9 depicts the whole word in keyboard format prompt preferably laminated and preferably in blue and/or yellow to optimize behavioral optometry skill sets.

FIG. 10 embodies the initially developed categorical possibilities of graphics and/or words among the inventions possible application to all educational and/or language curriculum.

FIG. 11 illustrates the multiple purpose internal and external reinforcement puzzle in 3D picture format with the whole word overlaying the preferred 2D and/or 3D graphic for further drag and drop matching purposes according to some embodiments of the disclosed invention. Puzzles with embedded whole word prompts are a lower gradient to have a win and maintain the learner's involvement in the less preferred tasks. Puzzles with embedded visual whole word typing key prompts and/or paired with phonetics may serve as an independent method among this technology's system itself.

### DETAILED DESCRIPTION

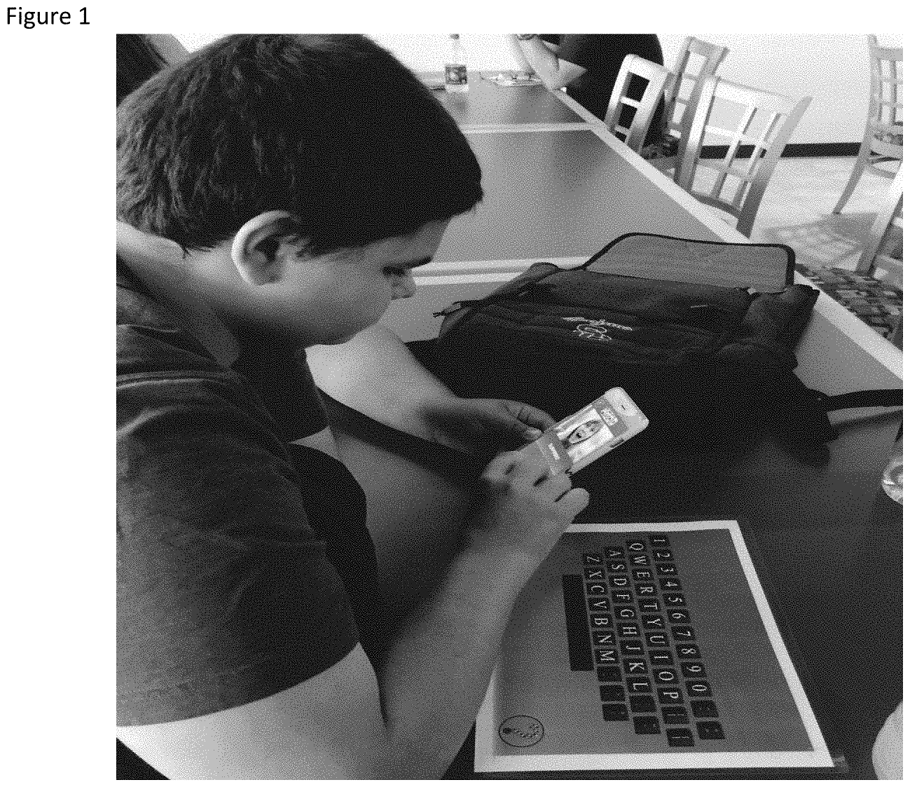

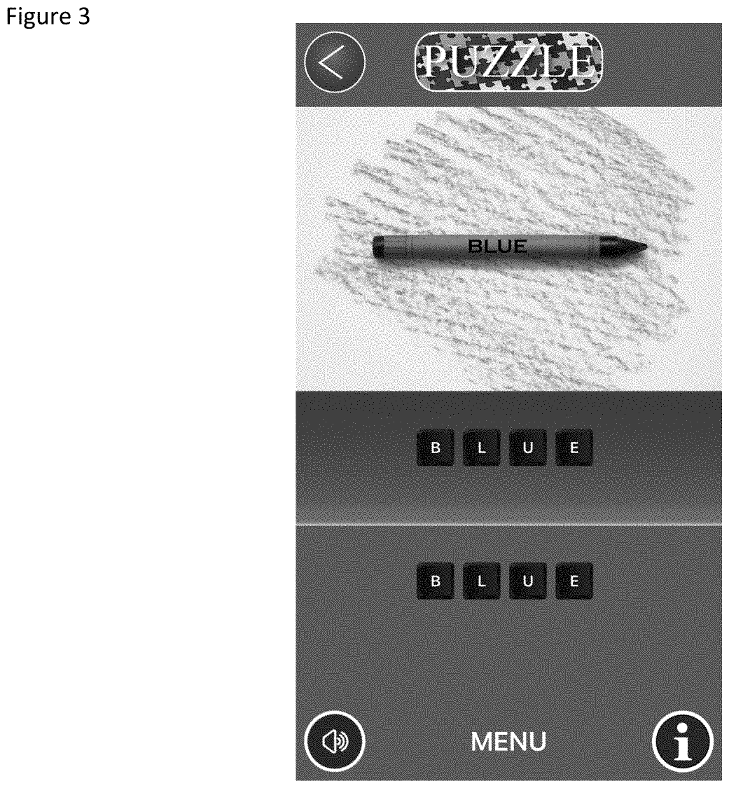

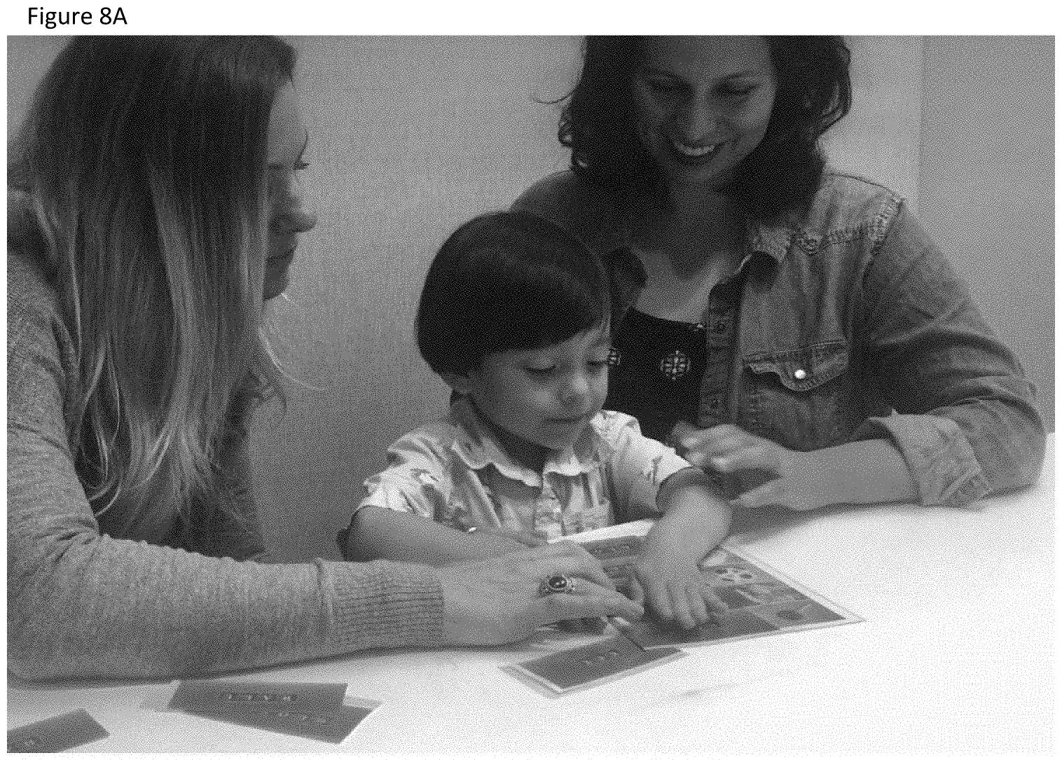

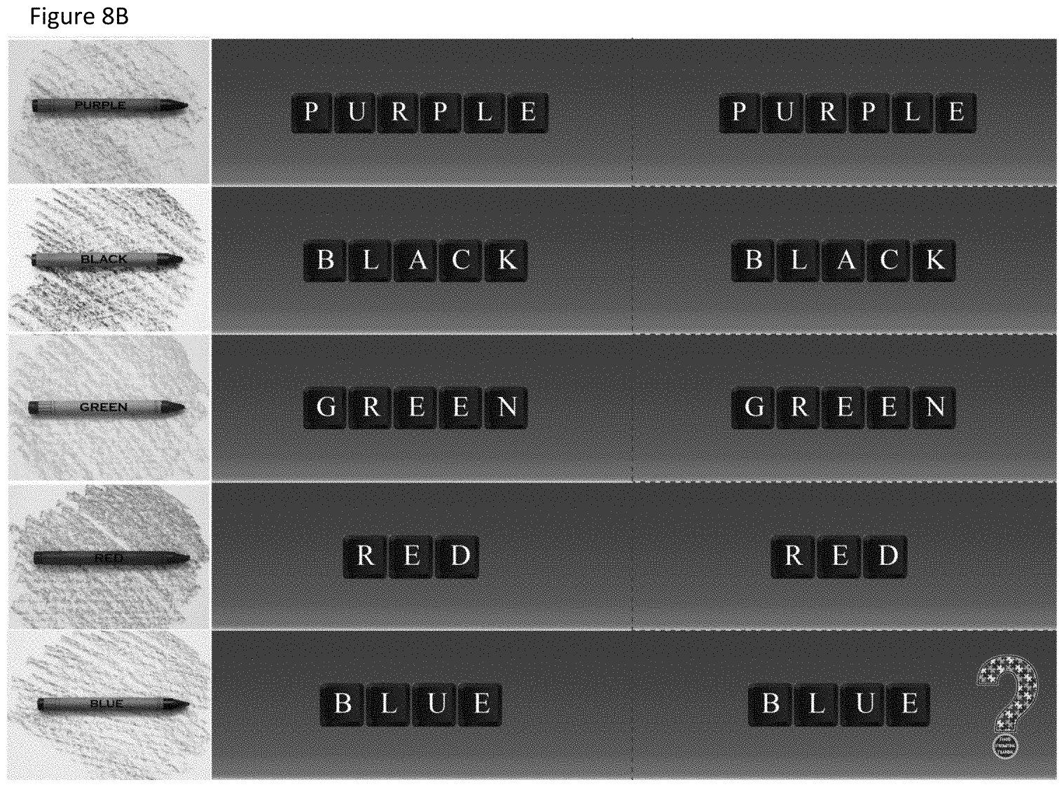

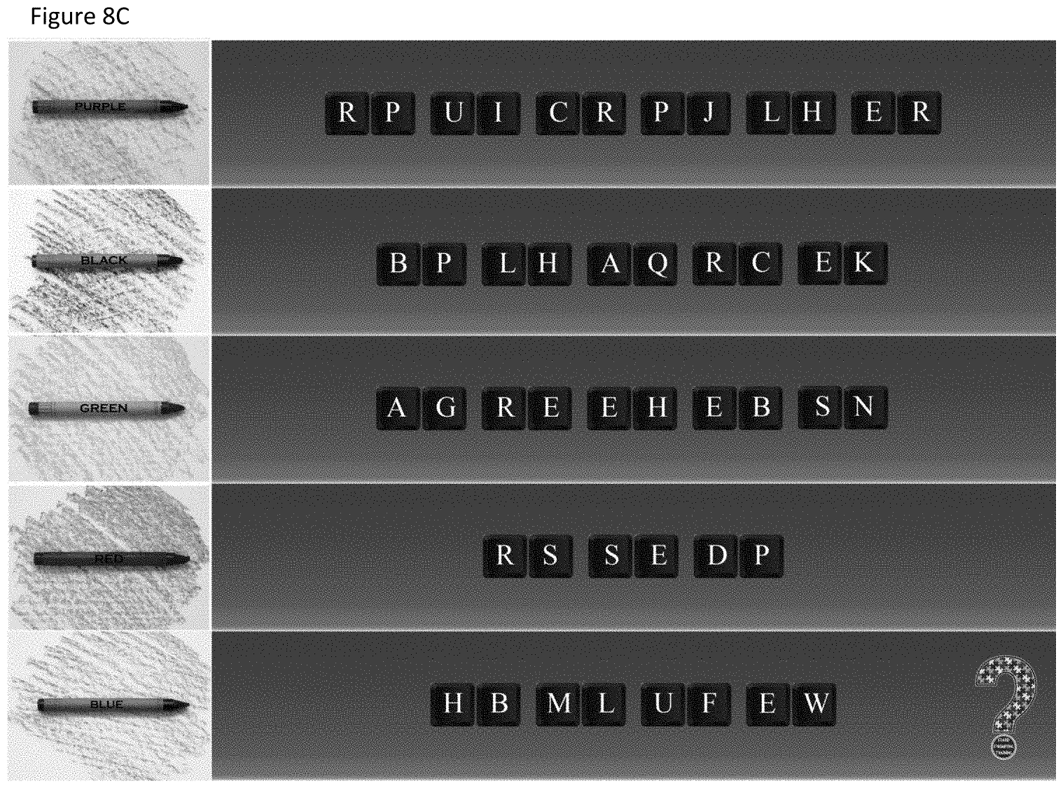

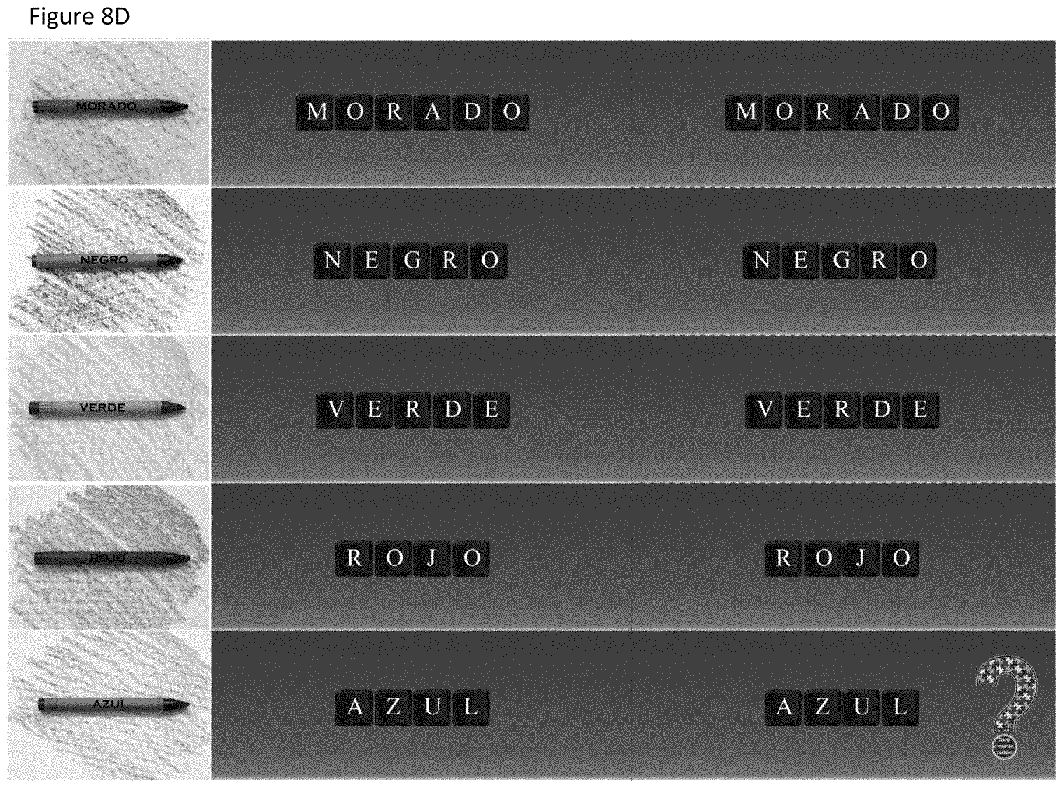

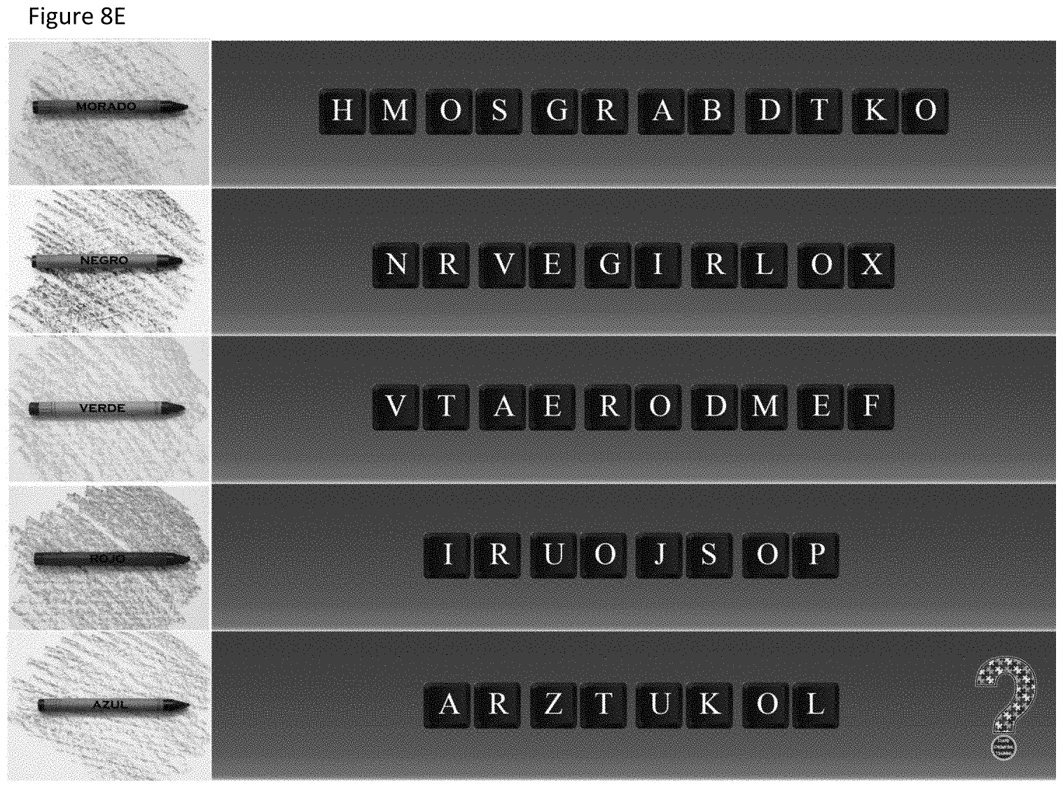

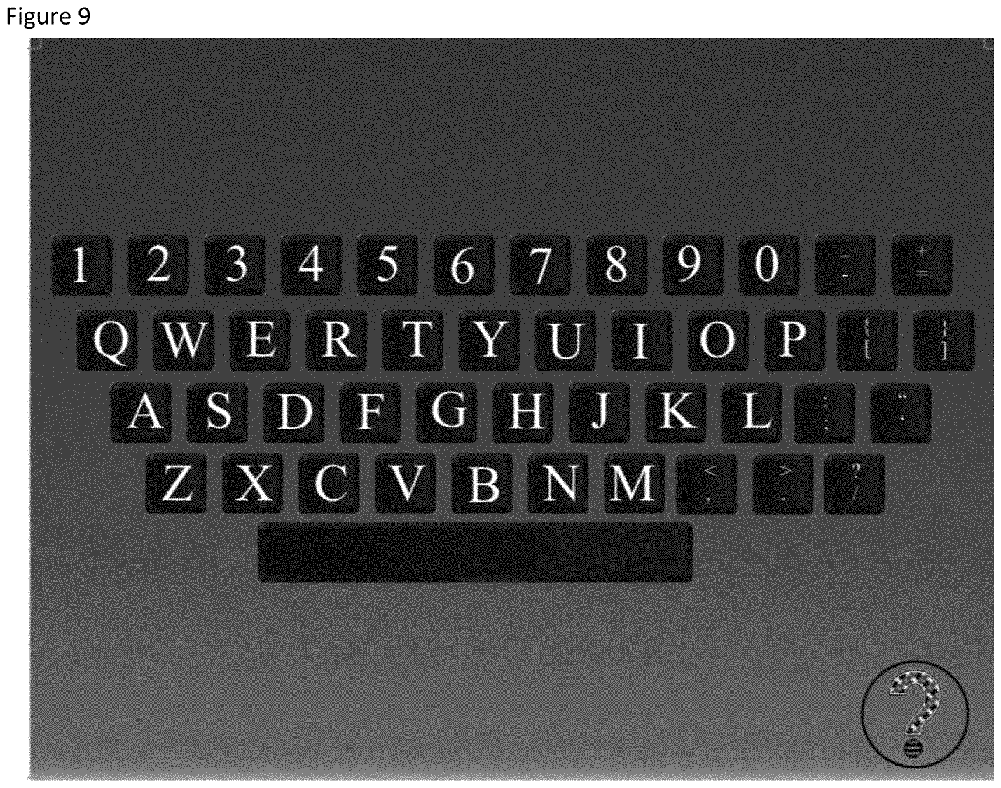

In some embodiments, conducting the use of the keyboard FIG. 1, matching and fading strategies FIG. 3; FIG. 8B; FIG. 8D in multiple natural and contrived environments digitally and/or physically FIG. 8A, while engaged preferably in a variety of calming, unimposing, excitatory visual, auditory, and sensory-based activities facilitates motivation, creates independence, reduces prompt dependency, and improves generalization of mastery. Understanding what motivates a learner to communicate FIG. 8A with the keyboard FIG. 1 increases the learner's motivation to engage during behavior and communication acquisition FIG. 9.

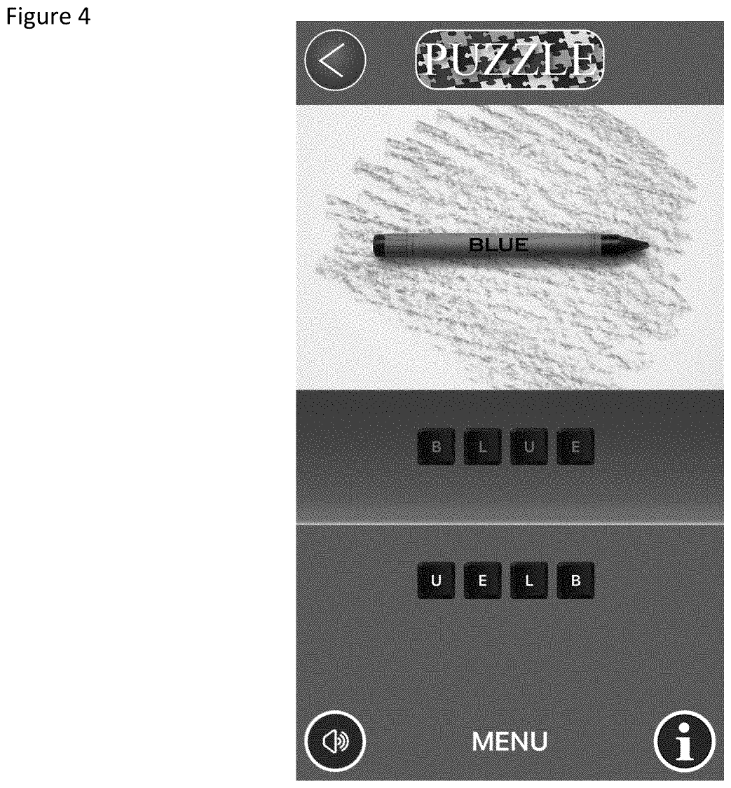

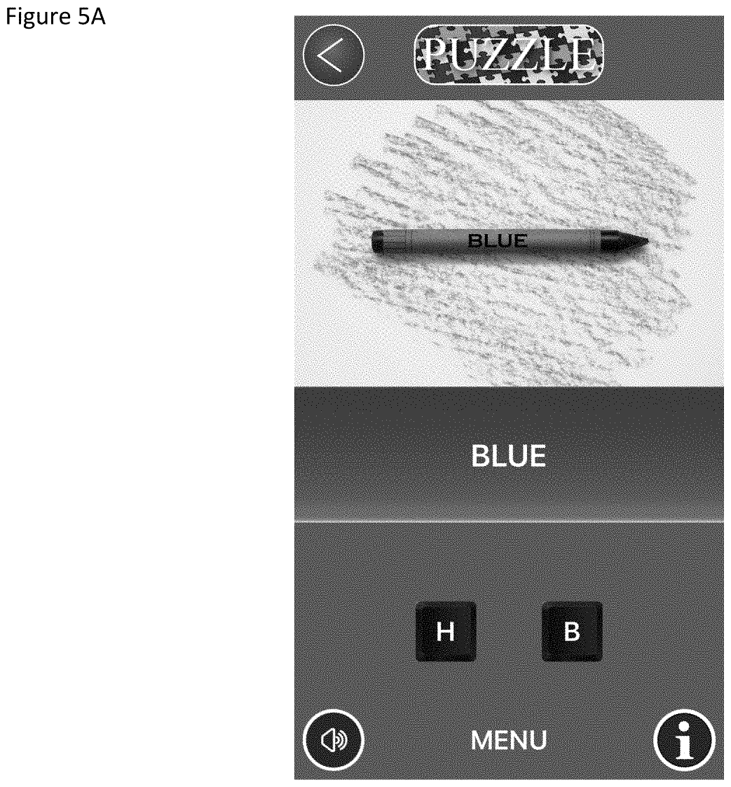

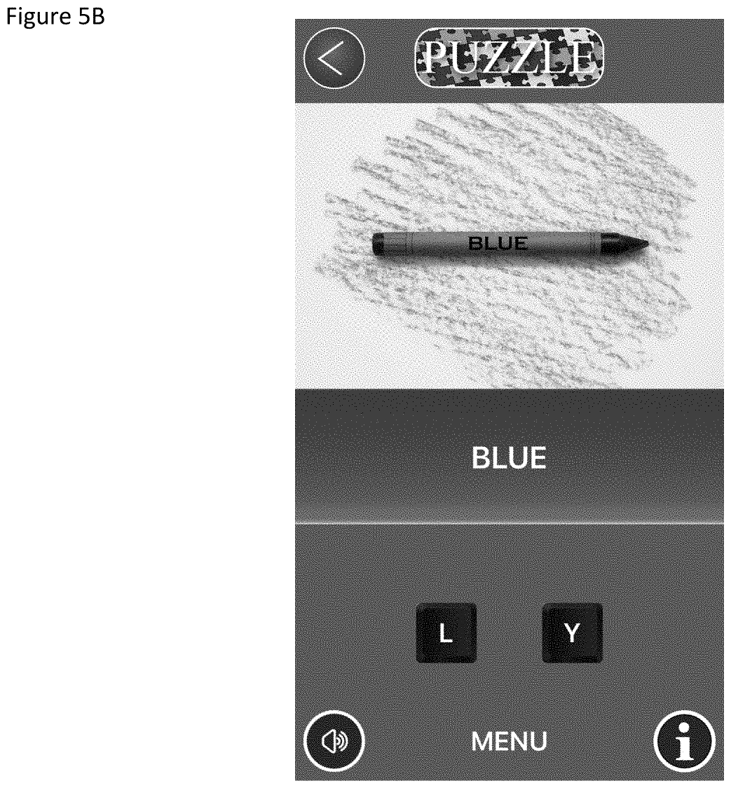

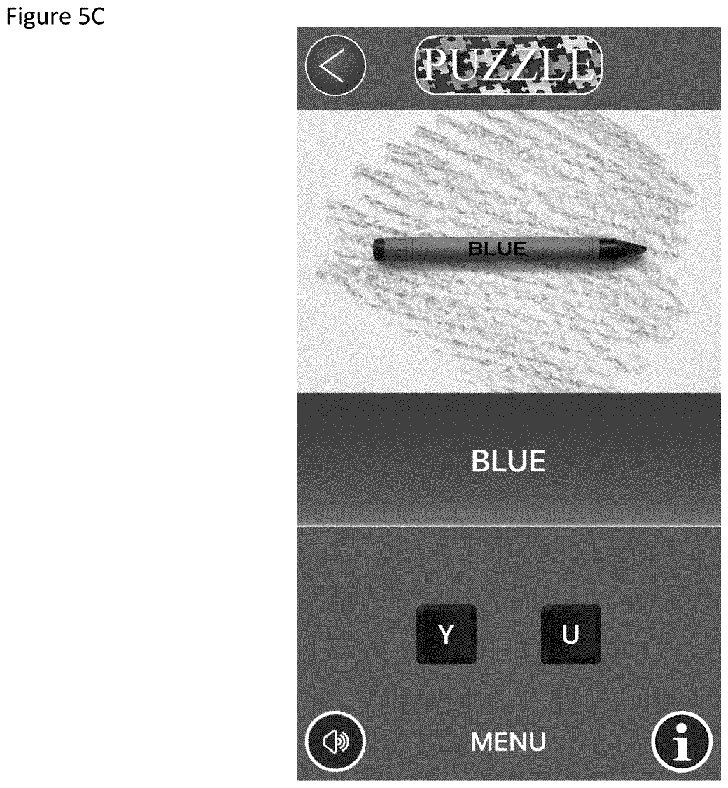

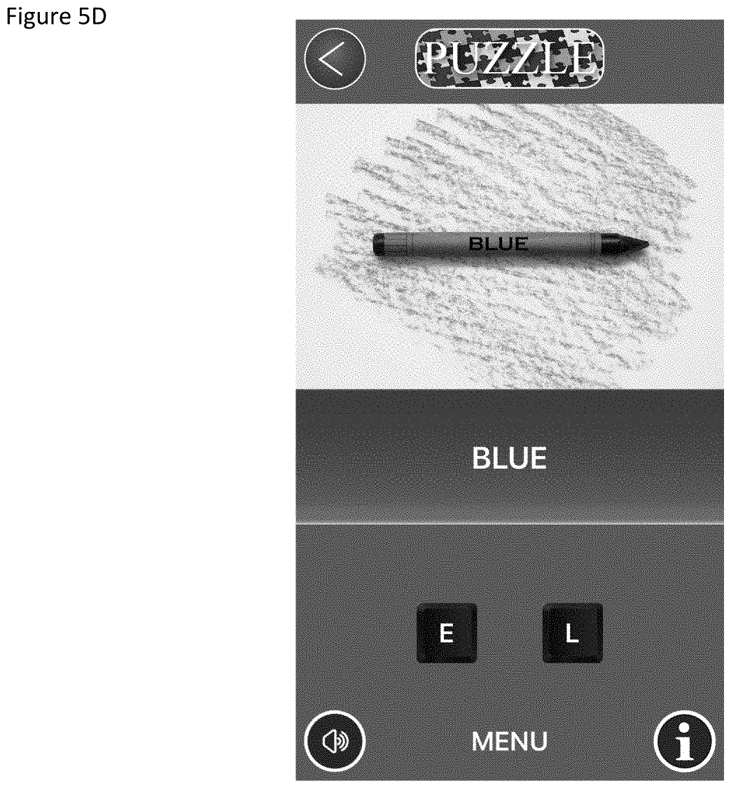

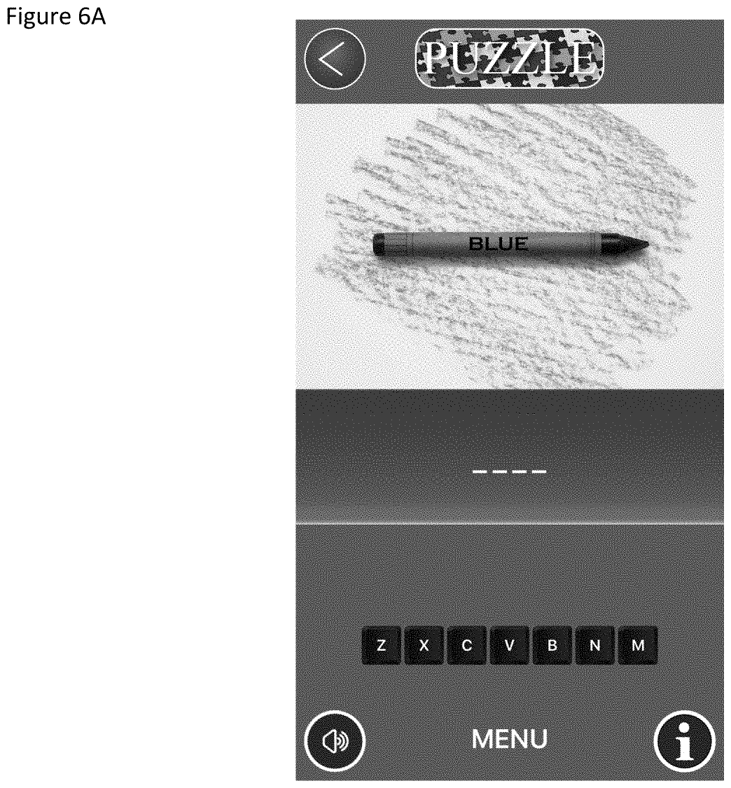

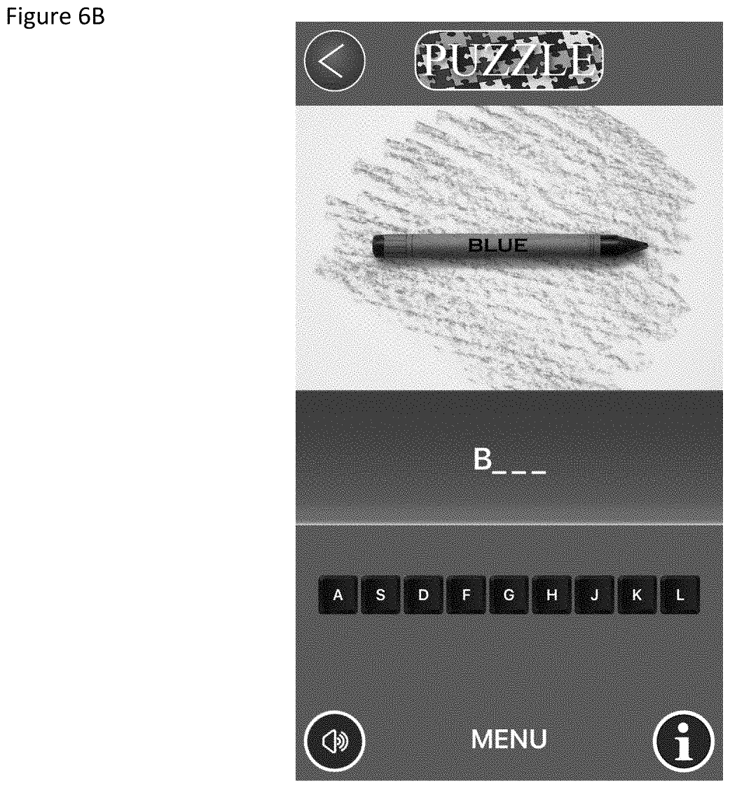

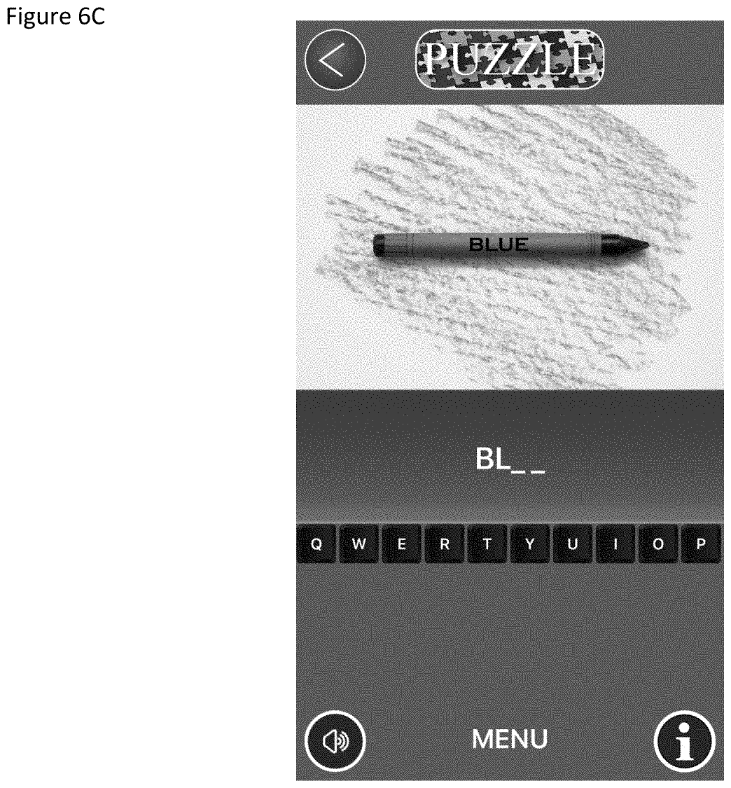

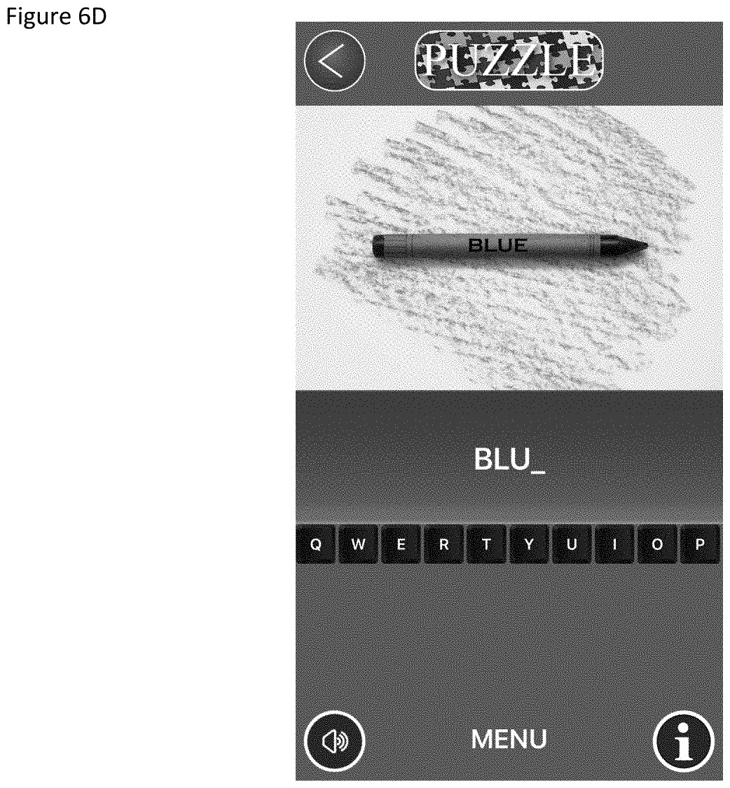

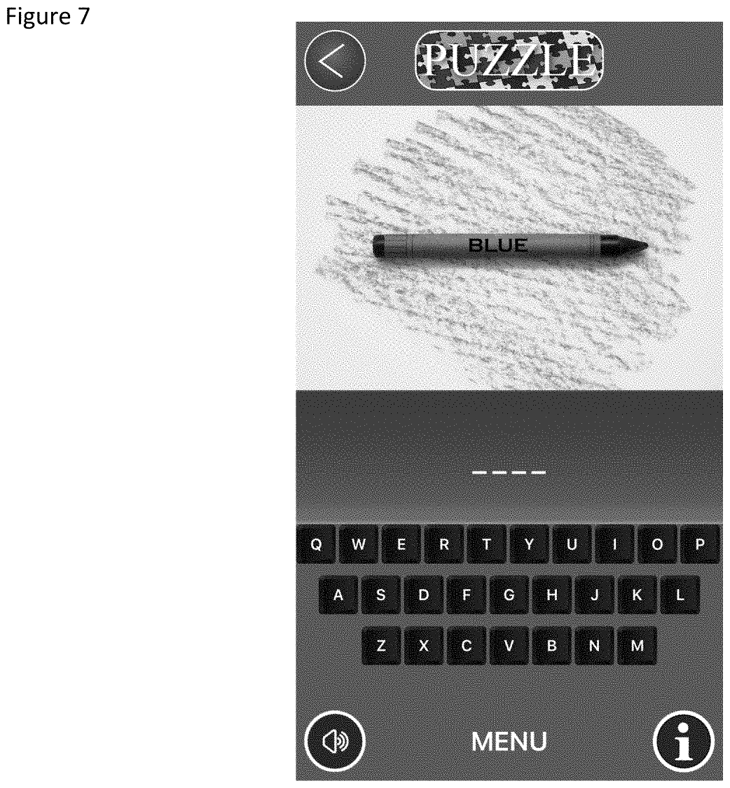

In some embodiments, the keyboard FIG. 9, when offered matching whole words in keyboard prompts FIG. 3; 8B; 8D, choices to complete the whole word spelling with distractor fields of two letter chooses FIG. 5 A-D; FIG. 8C; FIG. 8E, scrambled letter choices FIG. 4; FIG. 8C; FIG. 8E, row choices scaffolding from a standard QWERTY keyboard FIGS. 6A-D, and faded word prompts with an entire keyboard field FIG. 7; FIG. 9 perhaps motivates a learner to integrate his or her brain functioning, thus keeping the default network system deactivated and the task-positive network activated by scanning for choices, focusing attentively, and employing impacted motor skills. Videotaping the learner while using the system and method FIG. 1; FIG. 8A and then playing it back for him or her to see, equally possibly stimulates the learner's brain, interest, motivation, attending skills, and unfamiliar language acquisition.

Typically, YCCT increases motivation relying on internal reinforcements and external reinforcements simultaneously in the beginning perhaps. It can be used during structured teaching sessions FIG. 8A and in the context of the natural environment FIG. 1, such as eating, dressing, toileting, bathing, playing, etc. In YCCT, the learner naturally leads the trials with his or her own internal preference in a natural environment, and the therapist reinforces with the external reinforcement once the letters are pointed to FIG. 1; FIG. 8A.

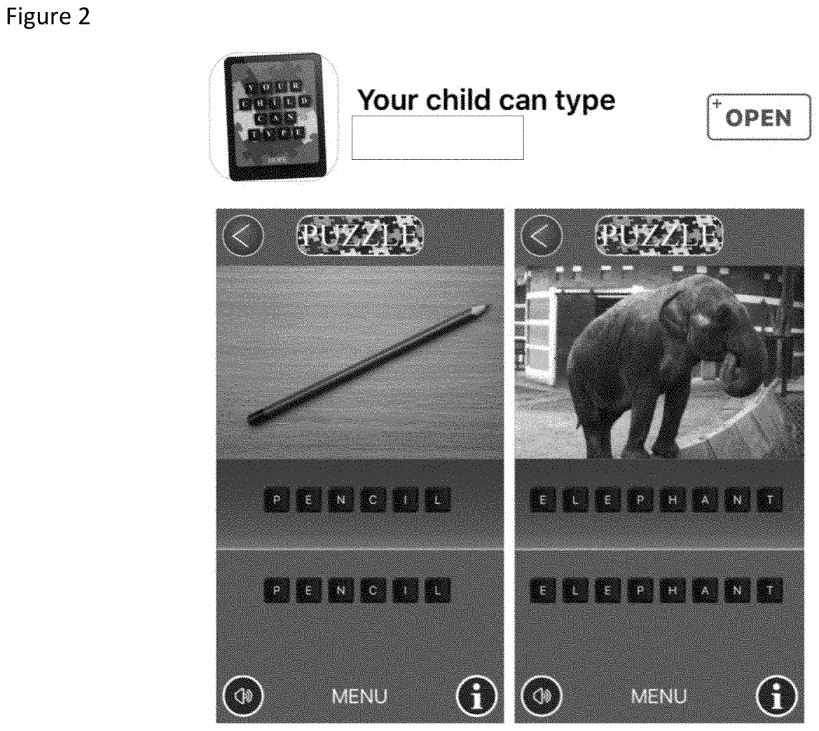

Conceivably using both internal motivation (mand) and external motivation (tact of the reinforcement) via digital gaming FIG. 1 and/or physical gaming FIG. 8A with a keyboard FIG. 9 and whole word matching FIG. 3; FIG. 8B; FIG. 8E simultaneously to this system and method of rapid fire random rotation, FIG. 4; FIG. 5A-D, FIG. 8C; FIG. 8E phonetics FIG. 2, and scaffold keyboard fields FIG. 6 A-D; FIG. 7 at the same time perhaps increases the motivation to visually attend, track the letters, and point to the letters accurately. For example, a learner is in the kitchen searching for a cookie.

Such specifications like many other keyboard devices, education, and behavior applications are accessible to learners under the possible premise of outdated theories, however, the use of a keyboard FIG. 9, when offered matching whole words in keyboard prompts FIG. 3; 8B; 8D, choices to complete the whole word spelling with distractor fields of two letter chooses FIG. 5 A-D; FIG. 8C; FIG. 8E, scrambled letter choices FIG. 4; FIG. 8C; FIG. 8E, row choices scaffolding from a standard QWERTY keyboard FIGS. 6A-D, and faded word prompts with an entire keyboard field FIG. 7; FIG. 9 is so possibly important because it postulates for visual and motor reference for the learner's information process of working memory, organization of thoughts, attending to stimuli, and staying focused. The keyboard FIG. 9 may also be used in adjunct with other methods of applied behavioral analysis, speech therapies, educational methods, etc., as well as in absence of self-stimulatory devices such as smart phones, smart pads and computers. It may reduce excitatory and obsessive behaviors, impeding learning and communicating that often occurs when using smart phones, smart pads and computers and other assistive technology devices. It offers ease of use, the ability to have them hung up in multiple locations, and can travel with ease.

In some embodiments, YCCT begins with a preference assessment to identify the highest internal and external reinforcements of verbal operants where other system and method fail. This is attempted to reinforce the use of the keyboard FIG. 9, when offered matching whole words in keyboard prompts FIG. 3; 8B; 8D, choices to complete the whole word spelling with distractor fields of two letter chooses FIG. 5 A-D; FIG. 8C; FIG. 8E, scrambled letter choices FIG. 4; FIG. 8C; FIG. 8E, row choices scaffolding from a standard QWERTY keyboard FIGS. 6A-D, and faded word prompts with an entire keyboard field FIG. 7; FIG. 9 paired with the stimulus discriminate. It encourages the left and right hemispheres to connect attentively to what comes next while exposes them to external and internal reinforcement derived from the use of the visual QWERTY and technological devises. Furthermore, hemispheric connectivity possibly encourages the optic nerve to track left and right FIG. 4; FIG. 5A-D, FIG. 8C; FIG. 8E quickly perhaps fosters working memory and attending, with both the highest levels of reinforcement needed for success. The external reinforcement may fade on the learner's internal reinforcement taking over the desire for mastery.

Internally and externally motivated behavior paired with automatic reinforcement and external reinforcement of behavior of the disclosed invention may allow for multiple methods to a. to obtain a desired event: internal stimulation or to obtain a social event; attention or activities/objects b. to escape or avoid in undesirable event: to escape/avoid internal stimulation or to escape/avoid social events; attention or activities/objects to achieve the use of this system and method establishing independent communication, phenome awareness, and new language acquisition quickly during brain enhancement activities.

In some embodiments, operant behaviors are facilitated by eliciting a response from the learner with the use of a keyboard FIG. 9, when offered matching whole words in keyboard prompts FIG. 3; 8B; 8D, choices to complete the whole word spelling with distractor fields of two letter chooses FIG. 5 A-D; FIG. 8C; FIG. 8E, scrambled letter choices FIG. 4; FIG. 8C; FIG. 8E, row choices scaffolding from a standard QWERTY keyboard FIGS. 6A-D, and faded word prompts with an entire keyboard field FIG. 7; FIG. 9 specific to this system and method of rapid fire random rotation, phonetics, and scaffold keyboard fields that includes, at a basic level, mands, echoics, tacts, and intraverbals. A mand is important to understand among the use of a keyboard because it is the only operant said to have an internal reinforcement for the learner, while the other verbal operants are reinforced by secondary or external reinforcements.

YYCT perhaps now bridges the internal and external motivation gap with stimulated fantasy areas of the brain among neuroscience implications where reality versus fantasy areas of the brain are now activated with computing and/or gaming modalities. Remembering to maintain important verbal behavior teaching procedures based on the operant variances; teaching visual motor pointing success first; and initially start with high levels of reinforcement, paired with the most difficult task presented in a variable ratio schedule fosters learner acquisition possibly faster. Complete in small intervals initially with random rotation letters, working up to larger intervals. Work in a natural environment preferably, intersperse the difficult tasks with those tasks already mastered, use prompting beneficial with the correct answers quickly, and then fade prompt quickly. Incorporating healthy cognitive statements for social-emotional growth, while stimulating information processing for memory is crucially important to embodiments among this invention.

The embodiments include operant antecedent/stimuli behavior consequence mand with the use of a keyboard FIG. 1; FIG. 8, A; FIG. 9, when offered matching whole words in keyboard prompts FIG. 3; 8B; 8D, choices to complete the whole word spelling with distractor fields of two letter chooses FIG. 5 A-D; FIG. 8C; FIG. 8E, scrambled letter choices FIG. 4; FIG. 8C; FIG. 8E, row choices scaffolding from a standard QWERTY keyboard FIGS. 6A-D, and faded word prompts with an entire keyboard field FIG. 7; FIG. 9 simultaneously to this system and method of rapid fire random rotation, phonetics, and scaffold keyboard fields: request; to ask for something (a comMAND, deMAND, or counterMAND) due to deprivation or aversive stimulation.

Motivating the learner with a keyboard, matching and fading accordingly yields a mand becomes simple learning and digital or physical game motivation generalized to actual motivation of acquiring the 3D object perhaps.

Example in the food item category:
1. Motivation of hunger.
2. Motivation of dry mouth from eating a cookie.
1. Says/Types
“cookie.”
2. Says/Types
“water.”
1. Gets the cookie.
2. Gets water or pushes away a cookie after offering.
Receptive Language: Following directions of others.
Give me the cookie.
The learner gives the cookie.
Social/secondary reinforcer. Operant Antecedent/Stimuli Behavior Consequence Commented
Imitation: Imitation is point-to-point correspondence between person and the learner's behavior.
The teacher says, “Yum, eat the cookie.”
Learner imitates eating the cookie.
Social/secondary reinforcer.
Echoic: Repeating a word or sound that the speaker says.
Say “cookie.”
Says/Types “cookie.”
Social/secondary reinforcer.
Tact: To label something (something you come in conTACT with).
Sees a cookie.
Says/Types “cookie.”
Social/secondary reinforcer.
Intraverbal: A fill in the blank or response to a question without the topic of conversation present.
We eat . . . .
Says/Types “cookie.”
Social/secondary reinforcer.
Autoclitic: Modifies the functions of other verbal behaviors.
You like . . . .
Says/Types, “I like cookies.”
Social/primary/secondary reinforcer

In some embodiments, educational and applied behavioral analysis theory of verbal operants using a keyboard FIG. 9, when offered matching whole words in keyboard prompts FIG. 3; 8B; 8D, choices to complete the whole word spelling with distractor fields of two letter chooses FIG. 5 A-D; FIG. 8C; FIG. 8E, scrambled letter choices FIG. 4; FIG. 8C; FIG. 8E, row choices scaffolding from a standard QWERTY keyboard FIGS. 6A-D, and faded word prompts with an entire keyboard field FIG. 7; FIG. 9 can increase various aspects of goal mastery by fostering the basis of how the brain and body work collectively together with impaired visual, auditory, tactile, kinesthetic, motor skills, and joint attention. Nonverbal and visual thinking skills are generally strengths for those possibly learning with YYCT. Therefore, matching characteristics, both 2D and 3D, with a laminated alphabetic sheet and/or assistive or augmentative communication devises is possibly an optimal starting point. It may help the learner to associate items generally manded in their natural environment to a virtual environment with paired keyboards to develops independence in tasks, helps with generalization in expressive and receptive labeling, and is a precursor to many other aspects that require attention.

Accordingly, vision dominances vary based on 2D versus 3D across the spectrum, making it erroneously appear that matching difficulties exist for some alphabetic symbolic language system, combined with 2D and 3D associations, perhaps covers all areas of brain functioning, more likely leading to greater success. It conceivably takes into account auditory and vocal skills; generally, their greatest deficit, because we always sound out the letters, as the learner chooses the correct letter out of a field of two, in early stages of use, to a larger field as they progress among a keyboard.

By accordingly sounding out the letters of a whole word, prompted with for example individual letters comprising the spelling such as b-l-u-e, and corresponding descriptive visuals with sound similarity precisely matched embodies visual, auditory, and motor awareness concurrently. Giving learners the visual and auditory stimuli with options to point to the laminated alphabetic sheet out of a field of 2, 7, 8, 9, and then 26 total alphabetic letters FIGS. 6A-D; FIG. 7; FIG. 9 organized in keyboard format embodies feasible neuroscience working memory and processing evidence.

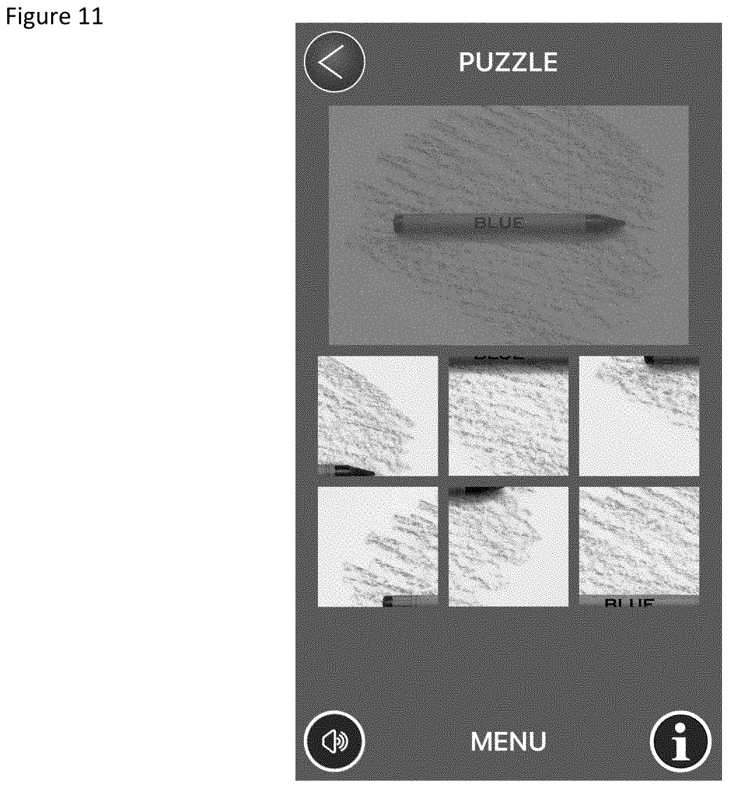

Accordingly, the possible teaching receptive language with a keyboard FIG. 9 and/or puzzle FIG. 11, when offered matching whole words in keyboard prompts FIG. 3; 8B; 8D, choices to complete the whole word spelling with distractor fields of two letter chooses FIG. 5 A-D; FIG. 8C; FIG. 8E, scrambled letter choices FIG. 4; FIG. 8C; FIG. 8E, row choices scaffolding from a standard QWERTY keyboard FIGS. 6A-D, and faded word prompts with an entire keyboard field FIG. 7; FIG. 9 simultaneously to this system and method of rapid fire random rotation, phonetics, and scaffold keyboard fields. Supplement verbal information with pictures, visual schedules, gestures, visual examples, written directions, etc. conceivably allots working memory and language acquisition advancements. Doing so while paired with a keyboard and/or keyboard letter prompt and/or phonetics independently and/or simultaneously is likely imperative. Typically, research indicates up to 75 percent of those diagnosed with learning delays also have a central auditory processing disorder concluding possible need for simultaneous visual, motor, and auditory prompts towards repair.

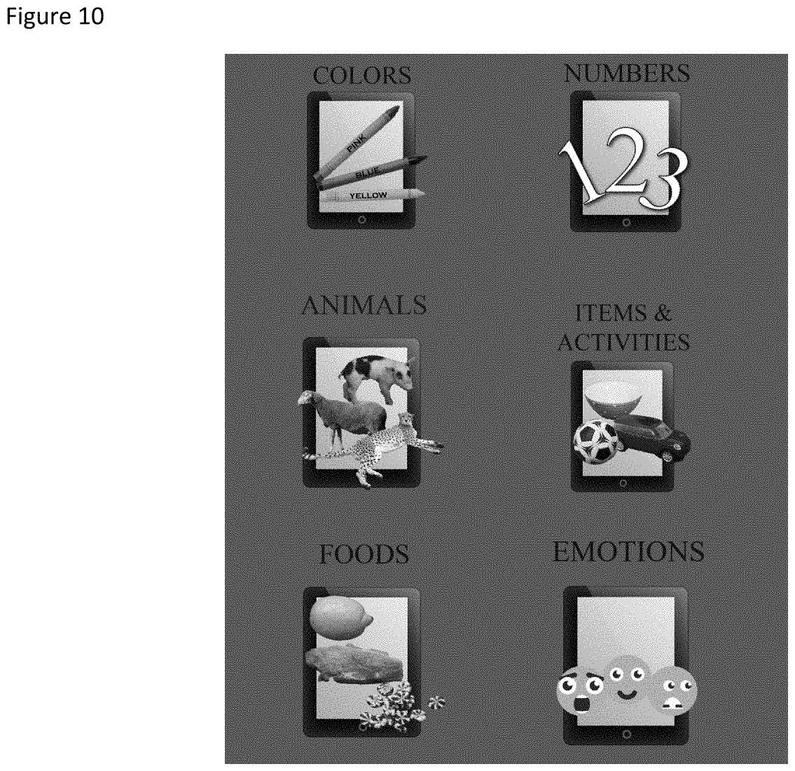

Considering the learner's processing challenges and proceeding with quick timing whole word keyboard matching, random rotation of letters, gradient keyboards prompts, combined graphic and letter and or/word combined puzzles. and phonetic prompts to maintain attention and focus perhaps vastly improves learning and/or language acquisition by pairing what is auditorily stated to encourage the learner's receptive understanding FIG. 1; FIG. 2; FIG. 3; FIG. 4; FIG. 5A-D; FIGS. 6A-D, FIG. 7; FIG. 8A-E; FIG. 9; FIG. 10. This possibly increases the likelihood that the learner is attending internally and externally while following along with visual, motor, kinesthetic, and auditory dominant learning styles at the same time. Beginning with simple positively motivating words, avoiding complex verbal directions, information, and discussion conceivably increases desirable attention to learning under the impression of play. Immediately repeat the language prompt, while gesturally cueing the learner to point at the beginning field of two FIG. 3; FIG. 4; FIG. 5 A-D; 6A-D, FIG. 8A-E; FIG. 11, then expanding to larger fields is possibly FIG. 7 may prove beneficial.

Teaching expressive language with a keyboard FIG. 9, when offered matching whole words in keyboard prompts FIG. 3; 8B; 8D, choices to complete the whole word spelling with distractor fields of two letter chooses FIG. 5 A-D; FIG. 8C; FIG. 8E, scrambled letter choices FIG. 4; FIG. 8C; FIG. 8E, row choices scaffolding from a standard QWERTY keyboard FIGS. 6A-D, faded word prompts with an entire keyboard field FIG. 7; FIG. 9, and phonetic prompts FIG. 2 targets working memory and word retrieval issues, even if they know the answer is probably crucial to working memory and behavioral development. The learner oftentimes can't express the language in their minds. Much of this is perhaps due to delay or underdevelopment to their sensory motor neurons and motor processing previously misunderstood. Utilizing a keyboard and/or random rotation of letters, simultaneously with visual supports and multiple-choice options, while beginning with a field of two and/or expanding to higher gradients, possibly rectifies their presented deficits. For example, if we are teaching a learner to ask for their favorite toy or edible, have a real-life picture of the “train” or “cookie,” labeled with the words.

For the purposes of the system and method of the disclosed invention, utilizing mands with a keyboard FIG. 9, when offered matching whole words in keyboard prompts FIG. 3; 8B; 8D, choices to complete the whole word spelling with distractor fields of two letter chooses FIG. 5 A-D; FIG. 8C; FIG. 8E, scrambled letter choices FIG. 4; FIG. 8C; FIG. 8E, row choices scaffolding from a standard QWERTY keyboard FIGS. 6A-D, faded word prompts with an entire keyboard field FIG. 7; FIG. 9, and phonetic prompts FIG. 2 may have a profound impact on brain development transpiring into advanced learning acquisition and communication skills. A mand is the foundation of all other verbal behavior. The learner may learn to ask for a need or want with or without the item in their vision or presence. Behaviorists call an “impure mand” results from an establishing operation and the stimulus discriminate being asked, “What do you want?” A “pure mand,” results from the establishing operation being requested without being asked by someone. Mands also occur from peers, in sentences, for attention, and for information.

Choosing to begin with highly reinforcing needs or wants FIG. 10; FIG. 11 may allow the desired by the learner via computer computing and/or physical games/toys, as well as natural environment applications, for example, a cookie. Present the cookie paired with a 2D-identical picture of the cookie with the identical letters “c-o-o-k-i-e,” laminated to present as the 2D with a keyboard present. Start with a field of one, prompting the learner to point to the letters. Once completed, provide the cookie for reinforcement. Multiple trials are possibly necessary. Once one letter acquisition is mastered FIG. 3; FIG. 8B; FIG. 8D, move to a field of two. Once a field of two is mastered, move to a field of four. Do NOT move to a field of three because you will train the learner to select the middle and not discern. The conceivable long-term goal is to have the entire 26 alphabet keyboard chosen from FIG. 9, transferred to an actual keyboard independently.

Some embodiments may initially employ a mand, with for example any educational curriculum and/or any language program, with a keyboard FIG. 9 transferring from an echoic. For example, if a learner sees a cookie, but might not necessarily want the cookie, the presenter says, “cookie.” The learner may spell cookie independently on the keyboard FIG. 9, and then the teacher offers social or secondary reinforcement for spelling cookie. Mands are also often taught as a tact transferring the mand when learning new words via typing. If a learner wants chips, but mands “cookie,” we can redirect the learner to spelling juice on a keyboard with small or large fields FIG. 9 saying, “This is juice,” presenting the keyboard FIG. 9, when offered matching whole words in keyboard prompts FIG. 3; 8B; 8D, choices to complete the whole word spelling with distractor fields of two letter chooses FIG. 5 A-D; FIG. 8C; FIG. 8E, scrambled letter choices FIG. 4; FIG. 8C; FIG. 8E, row choices scaffolding from a standard QWERTY keyboard FIGS. 6A-D, faded word prompts with an entire keyboard field FIG. 7; FIG. 9, and phonetic prompts FIG. 2 if activated. If you know the learner can tact chip, then hold up the chip and also say, “What is this?” Perhaps present the chip with the keyboard and then reinforce after mastery.

The rules, procedures, and ordered sequence herein may be incorporated via reinforcement to the first tact with a generalized reinforcement such as puzzles embodied in this method FIG. 11. This is intrinsically itself the game format both digitally and physically, and, exemplified by the transfer it to a pure mand. It is important to possibly transfer to the independent, so that the learner does not become dependent on the prompts provided. It is also vital to attempt to possibly provide the least-intrusive prompt, that is, if the learner is successful with fill-ins, use those instead of echoic, as that is a less-intrusive prompt.

After initial conformity with the system and method, the established mand may ultimately be taught with, “I want ______, please” by use of the keyboard FIG. 9 and/or scaffolding format. Utilizing the same process with new combined words to complete an entire sentence such as “I want ______, please” introduce with this innovated system and method employing a keyboard FIG. 9, when offered matching whole words in keyboard prompts FIG. 3; 8B; 8D, choices to complete the whole word spelling with distractor fields of two letter chooses FIG. 5 A-D; FIG. 8C; FIG. 8E, scrambled letter choices FIG. 4; FIG. 8C; FIG. 8E, row choices scaffolding from a standard QWERTY keyboard FIGS. 6A-D, faded word prompts with an entire keyboard field FIG. 7; FIG. 9, and phonetic prompts FIG. 2. Complete the process by typing this on a paper to laminate for the learner to possibly learn manding highly desired reinforcement for requesting an item. Conceivably repeat the steps above beginning with fields of one letter, two letters, four letters, to an entire field of 26. Highly prompting with letter fields quickly may achieve optimal transitionary success. The pictures can perhaps quickly be faded, leaving only words with the learner reading, typing mands, echoics, and tacts.

According to some embodiments of the disclosed invention there are a few different types of response forms. Vocal, picture and object exchange, sign language, communication boards, as well as alternative and augmentative technology are plausible. Using the keyboard FIG. 9, when offered matching whole words in keyboard prompts FIG. 3; 8B; 8D, choices to complete the whole word spelling with distractor fields of two letter chooses FIG. 5 A-D; FIG. 8C; FIG. 8E, scrambled letter choices FIG. 4; FIG. 8C; FIG. 8E, row choices scaffolding from a standard QWERTY keyboard FIGS. 6A-D, faded word prompts with an entire keyboard field FIG. 7; FIG. 9, and phonetic prompts FIG. 2 may be useful for both vocal and nonvocal because humans all use letters and symbols to communicate and employ verbal operants. In order for the left and right hemispheres to connect and pay attention to what comes next, and foster working memory, the integrating keyboard, whole word matching, and rapid fire random rotation with phonetics are possible methods of consideration. The use of a keyboard with aforementioned scaffolding and/or letter search and/or random rotation strategies may encourage functional behaviors, vocal production, engagement, and rapid learning of new curriculum and/or unknown spoken languages.

Some embodiments teaching echoics with a keyboard FIG. 9, when offered matching whole words in keyboard prompts FIG. 3; 8B; 8D, choices to complete the whole word spelling with distractor fields of two letter chooses FIG. 5 A-D; FIG. 8C; FIG. 8E, scrambled letter choices FIG. 4; FIG. 8C; FIG. 8E, row choices scaffolding from a standard QWERTY keyboard FIGS. 6A-D, faded word prompts with an entire keyboard field FIG. 7; FIG. 9, and phonetic prompts FIG. 2 employs the word itself as descriptive. Echoing the word presented and spelling it simultaneously on a letter board may still maintain the prior definition of an echoic. For example, the teacher says “cookie,” and the learner responds with “cookie.” Echoics can be taught with the keyboard the same way the mands are taught; the only difference is there is no internal reinforcement or motivation. Say the letters out loud for the learner as he or she points to the correct echoic for possible advancements otherwise unobtained. Reinforcement for an echoic, once pointing to the correct letters out of the fields, may be given if needed.

Typically teaching tacts with a keyboard FIG. 9, when offered matching whole words in keyboard prompts FIG. 3; 8B; 8D, choices to complete the whole word spelling with distractor fields of two letter chooses FIG. 5 A-D; FIG. 8C; FIG. 8E, scrambled letter choices FIG. 4; FIG. 8C; FIG. 8E, row choices scaffolding from a standard QWERTY keyboard FIGS. 6A-D, faded word prompts with an entire keyboard field FIG. 7; FIG. 9, and phonetic prompts FIG. 2 tact means to label or name an item, action, or describe something within the environment of the learner. If a learner sees a cookie, but is not motivated or does not desire a cookie, labeling it “cookie” is a tact otherwise obtainable with the use of YYCT. The learner may also tact, “brown cookie.” The same procedural use of a keyboard perhaps applies here. Having the 2D-laminated picture of the item labeled with the correct spelling present with the 3D item may equally foster motivation and observable working memory acquisition. The learner may point to the field of one, then two, then four, and so forth. Once the learner possibly masters lower level tacts of labeling objects, then move on to actions, parts, features, classes, and functions.

For the purposes of the system and method teaching a learner intraverbals keyboard FIG. 9, when offered matching whole words in keyboard prompts FIG. 3; 8B; 8D, choices to complete the whole word spelling with distractor fields of two letter chooses FIG. 5 A-D; FIG. 8C; FIG. 8E, scrambled letter choices FIG. 4; FIG. 8C; FIG. 8E, row choices scaffolding from a standard QWERTY keyboard FIGS. 6A-D, faded word prompts with an entire keyboard field FIG. 7; FIG. 9, and phonetic prompts FIG. 2 interaction between verbal expressions, such as perhaps completing sentences, word associations, categorizing, and answering questions are intraverbals. For example, cookies are associated with pastries, while chocolate-chip cookies are categorized under types of cookies. Intraverbals allow conversations to occur derived from mands. Intraverbals can be transferred from fill-ins, tacts, or echoics by using a keyboard to conceivably facilitate exchanges between listener and speaker, teacher and learner.

Such specifications may also require training stimulus equivalence with a keyboard FIG. 9, when offered matching whole words in keyboard prompts FIG. 3; 8B; 8D, choices to complete the whole word spelling with distractor fields of two letter chooses FIG. 5 A-D; FIG. 8C; FIG. 8E, scrambled letter choices FIG. 4; FIG. 8C; FIG. 8E, row choices scaffolding from a standard QWERTY keyboard FIGS. 6A-D, faded word prompts with an entire keyboard field FIG. 7; FIG. 9, and phonetic prompts FIG. 2. Matching to 2D and 3D samples with a keyboard FIG. 9, when offered matching whole words in keyboard prompts FIG. 3; 8B; 8D, choices to complete the whole word spelling with distractor fields of two letter chooses FIG. 5 A-D; FIG. 8C; FIG. 8E, scrambled letter choices FIG. 4; FIG. 8C; FIG. 8E, row choices scaffolding from a standard QWERTY keyboard FIGS. 6A-D, faded word prompts with an entire keyboard field FIG. 7; FIG. 9, and phonetic prompts FIG. 2, to possibly achieve reflexivity, symmetry, and transitivity across the same stimulus class is a plausible way to quickly train working memory and visual motor integration generalizations to other members in an equivalent class, with long-term knowledge acquisition. Training an operant response this way, in the presence of a stimulus that is the member of the equivalence class, may maximize applied neuroscience, applied behavioral analysis, and education among this system and method invention.

For all stimuli (any condition, event, or change in the physical world) in a class possibly exerts control over a learner's behavior, a single common feature of the lesson or skill taught encourages the hemispheres of the brain to connect via associative processes that research has perhaps proven improves working memory. A stimulus class is a group of stimuli with a common effect on a response class in theory. Discriminative stimuli might have one or more common properties when possible incorporated within this system and method. For example, a red apple, a red toy, and a red pen, are all part of a stimulus class that represents red. Control by the commonality, “red,” can possibly be demonstrated when an individual correctly selects the red items from an array of different colored items quickly, when the laminated alphabetic sheet field is provided, moving along quickly with the training stimulus equivalents by matching to various samples with letters matched a keyboard FIG. 9, when offered matching whole words in keyboard or randomly distracted FIG. 4; FIG. 8C; FIG. 8E on the board. That is, spelling “red” would be the single, common formal feature that evokes the same behavior (selecting the red item) may occur.

In some embodiments, to achieve reflexivity with a keyboard FIG. 9, when offered matching whole words in keyboard prompts FIG. 3; 8B; 8D, choices to complete the whole word spelling with distractor fields of two letter chooses FIG. 5 A-D; FIG. 8C; FIG. 8E, scrambled letter choices FIG. 4; FIG. 8C; FIG. 8E, row choices scaffolding from a standard QWERTY keyboard FIGS. 6A-D, faded word prompts with an entire keyboard field FIG. 7; FIG. 9, and phonetic prompts FIG. 2, the learner may select A given A, B given B, C given C, and so on. For example, a 2D-laminated picture of “cookie,” labeled “c-o-o-k-i-e,” with a 3D cookie for reinforcement FIG. 3; FIG. 8A; FIG. 8D once the learner spells cookie out of a baseline field possibly transpires. The learner perhaps selects an identical stimulus as the reinforcement upon pointing.

Typically, to mastery symmetry, the learner is taught to select B given A, and to select C given B. For example, given the picture of the cookie, say “cookie,” with a field of various stimuli for options and the learner points to the cookie on the keyboard. Following training, the learner may be able to select A given B, and to select B given C. The learner is possibly taught to select B given A, but as a result of training, can also select A given B with a keyboard and/or gaming prompt.

Among this system and method to achieve transitivity, the learner is taught to select B given A, and to select C given B with whole word matching the learner with a keyboard FIG. 9, when offered matching whole words in keyboard prompts FIG. 3; 8B; 8D and/or letter searches FIG. 4; FIG. 8C; FIG. 8E and/or puzzles FIG. 10. For example, given the spoken or modeled typed word, “cookie,” the learner perhaps spells “cookie,” and with the spoken word or modeled typed word, “cookie,” the learner selects to a different looking type of cooking out of a field. Then with no further training, the learner with a keyboard FIG. 9, when offered matching whole words in keyboard prompts FIG. 3; 8B; 8D, choices to complete the whole word spelling with distractor fields of two letter chooses FIG. 5 A-D; FIG. 8C; FIG. 8E, scrambled letter choices FIG. 4; FIG. 8C; FIG. 8E, row choices scaffolding from a standard QWERTY keyboard FIGS. 6A-D, faded word prompts with an entire keyboard field FIG. 7; FIG. 9, and phonetic prompts FIG. 2 are typically established to yield training stimulus equivalence mastery. The learner system and method may facilitate the learner to select A given C, and to select C given A. The learner is perhaps taught to select B given A, and to select C given B, but possibly as a result of the training, can also select A given C, and can select C given A.

1. A method for establishing reading, spelling, phonetics and typing skills by effectively increasing working memory, visual motor integration, and interhemispheric communication areas of the brain, the method comprising:
provisioning a plurality of computing devices, each device including a hardware processor and associated memory and display with visual graphics and auditor prompts

2. The method of claim 1, wherein the enhancements in facilitated working memory communication areas of the brain is facilitated by introducing keyboard letters quickly gaining attention and fading quickly for memory retention facilitating whole words.

3. The method of claim 1, visual motor integration communication areas of the brain by means of utilization in the learners dominate hand and pointer finger dragging and dropping whole words of the gestalt hemisphere and individual letters of the logical hemisphere while optic processing is occurring.

4. The method of claim 1, wherein the inter-hemispheric communication areas of the brain by way of letters randomly rotating left and right, as well as up and down, enhance optic transfer of the left and right brain hemispheres while introducing alphabet and phonetic.

5. The method of claim 1 is the crucial skill development establishment by means of employing multifaceted visual graphics quickly prompted with whole word matching graphics by means of a 2D and 3D computing keyboard among individualized keyboard letter prompts.

6. The method of claim 1 by means of fading the whole word prompt into a random rotation of those letter choices among a letter scramble composing a whole word with paired phonetics further elicits the totality of increased working memory, visual motor integration and interhemispheric communication resulting in reading, spelling, phonetic awareness and typing skills.

7. The method of claim 1 employing gradient scaffolding of keyboard letters and fading their randomly rotated letters to a blank field without any whole word or letter keyboard graphic prompts increases working memory, visual motor integration and interhemispheric communication by means of establishing reading, spelling, phonetic awareness and typing skills.

8. A method for establishing reading, spelling, phonetics and typing skills by effectively increasing working memory, visual motor integration, and interhemispheric communication areas of the brain, the method comprising:
provisioning a plurality of physical printing products, each printed product with visual graphics

9. The method of claim 8, wherein the enhancements in facilitated working memory communication areas of the brain is facilitated by introducing keyboard letters quickly gaining attention and fading quickly for memory retention facilitating whole words.

10. The method of claim 8, visual motor integration communication areas of the brain by means of utilization in the learners dominate hand and pointer finger dragging and dropping whole words of the gestalt hemisphere and individual letters of the logical hemisphere while optic processing is occurring.

11. The method of claim 8, wherein the inter-hemispheric communication areas of the brain by way of letters randomly rotating left and right, as well as up and down, enhance optic transfer of the left and right brain hemispheres while introducing alphabet and phonetic.

12. The method of claim 8 is the crucial skill development establishment by means of employing multifaceted visual graphics quickly prompted with whole word matching graphics by means of a 2D and 3D computing keyboard among individualized keyboard letter prompts.

13. The method of claim 8 by means of fading the whole word prompt into a random rotation of those letter choices among a letter scramble composing a whole word with paired phonetics further elicits the totality of increased working memory, visual motor integration and interhemispheric communication resulting in reading, spelling, phonetic awareness and typing skills.

14. The method of claim 8 employing gradient scaffolding of keyboard letters and fading their randomly rotated letters to a blank field without any whole word or letter keyboard graphic prompts increases working memory, visual motor integration and interhemispheric communication by means of establishing reading, spelling, phonetic awareness and typing skills.
